(19) United States
(12) Patent Application Publication
(10) Pub. No.: US 2015/0120232 A1
(43) Pub. Date: Apr. 30, 2015

(54) SHAPE CALCULATION APPARATUS AND METHOD, MEASUREMENT APPARATUS, METHOD OF MANUFACTURING ARTICLE, STORAGE MEDIUM

(71) Applicants: CANON KABUSHIKI KAISHA, Tokyo (JP); National Institutes of Natural Sciences, Tokyo (JP)

(72) Inventors: Tetsuji OOTA, Utsunomiya-shi (JP); Mahito NEGISHI, Tokyo (JP); Takuya YAMASHITA, Tokyo (JP)

(21) Appl. No.: 14/526,959

(22) Filed: Oct. 29, 2014

(30) Foreign Application Priority Data
Oct. 31, 2013 (JP) 2013-227525
Sep. 11, 2014 (JP) 2014-185660

(51) Int. Cl. G01B 21/20

(52) U.S. Cl. CPC G01B 21/20
USPC 702/97

(57) ABSTRACT

A shape calculation apparatus obtains measurement data of a first shape of a first partial region on a surface to be measured, and obtains measurement data of a second shape of a second partial region partially overlapping the first partial region on the surface to be measured. The apparatus determines a first shape correction parameter and a second correction parameter so that the value of an evaluation function for evaluating shape data obtained by correcting the measurement data of the first and second shapes by the first shape correction parameter and the second correction parameter falls within a tolerance range. The apparatus generates shape data of an entire region including the first and second partial regions by respectively correcting the measurement data of the first and second shapes using the first shape correction parameter and the second correction parameter, and combining the corrected shape data.

### BACKGROUND OF THE INVENTION

1. Field of the Invention

The present invention relates to a shape calculation apparatus and method for calculating the shape of a surface to be measured, a measurement apparatus, a method of manufacturing an article, and a storage medium.

2. Description of the Related Art

In astronomy/space observation, the semiconductor industry, or the like, it is increasingly required to upsize an optical element to be used to the order of one to several meters. Upsizing a measurement apparatus to measure the shape of the element increases the measurement dynamic range, thereby decreasing the accuracy resolution and increasing the cost of the apparatus. To solve this problem, so-called stitch measurement is generally performed to obtain the overall shape by measuring the shapes of a plurality of partial regions of an object to be measured, and combining the shape data of the plurality of partial regions.

Japanese Patent Laid-Open No. 2004-125768 discloses one stitch measurement technique. In this literature, the shape data of partial regions are obtained, the orientation error of each partial region and a system error common to all the partial regions are set as variable parameters, and an evaluation function that minimizes the difference in overlapping regions of the respective partial regions is set. Linear least squares are used as a minimization method. In this example, if six degrees of freedom of the orientation error are provided to n partial regions, degrees of freedom, the number of which is equal to nth power of 6, are calculated. In general, in interference measurement or the like, since it is impossible to perform measurement if data itself includes an inclination, the inclination error is very small, and the orientation error can be approximated by linear calculation.

The technique described in Japanese Patent Laid-Open No. 2004-125768 is applicable to such interference measurement data and the like. On the other hand, as for measurement data such as measurement data of a three-dimensional shape measurement apparatus for which it is necessary to perform nonlinear calculation such as coordinate rotation to correct the orientation error, if six degrees of freedom of the orientation error are provided to the n partial regions, the number of degrees of freedom to be calculated is sixth power of n. In this case, the calculation amount is enormous, and thus it is difficult to apply the technique to practical measurement.

Japanese Patent Laid-Open No. 2009-294134 discloses another stitch technique. In this literature, the difference between the shape data of a partial region and its designed shape is represented by an evaluation function, and parameters are determined so that the evaluation function is minimized. In this example, even if six degrees of freedom of an orientation error are provided to n partial regions, 6n degrees of freedom are calculated. Even if nonlinear calculation such as coordinate rotation is performed as described above, it is possible to suppress the stitch calculation load.

In each of the above-described literatures, errors included in the result of measuring a partial region are only an orientation error and system error. That is, the orientation error includes translation/rotation components of the measurement result, and the system error is common to all the measurement results. In other words, in measurement of the partial regions, data are combined on the premise that only the orientation of an optical element changes for each measurement operation and the system error caused by an apparatus calibration value or the like is always constant for all the measurement operations.

However, in actual measurement, the measurement result of each partial region includes various measurement errors in addition to a change in orientation. For example, if measurement using interference light is performed, the optical path of the interference light changes according to a change in temperature or pressure in a measurement environment, resulting in an error in measurement value. Also, if the relative distance between the measurement reference and an object to be measured changes due to the temperature deformation of the apparatus structure or the like, an error occurs in measurement value. Alternatively, when an object to be measured is held on a measurement apparatus, a change in friction force at the holding position or holding point deforms the object to be measured, resulting in an error in measurement value.

These errors indicate the difference between respective measurement results when the same partial region is measured a plurality of times, and are expressed as so-called measurement reproducibility.

As described above, when performing stitch calculation using the shape data of a partial region whose shape measurement reproducibility is unsatisfactory, the conventional techniques set only the orientation error and system error as calculation parameters. If the measurement reproducibility is low, the shape data of overlapping regions do not coincide with each other. As a result, when combining the shape data, the discontinuity of the respective shape data in the vicinity of the overlapping regions particularly becomes large. Along with this, especially at the connection position of the partial regions, a higher-order spatial frequency error such as a step shape or edge shape becomes large.

### SUMMARY OF THE INVENTION

The present invention solves the above problem, and can obtain the overall shape at higher accuracy by connecting respective partial regions in consideration of measurement errors in addition to an orientation error and system error.

According to one aspect of the present invention, a shape calculation apparatus comprises an obtaining unit configured to obtain measurement data of a first shape of a first partial region on a surface to be measured, and obtain measurement data of a second shape of a second partial region partially overlapping the first partial region on the surface to be measured, a determination unit configured to determine a value of a first shape correction parameter for changing the first shape to compensate a measurement error included in the measurement data of the first shape and a value of a second correction parameter for compensating a measurement error included in the measurement data of the second shape so that a value of an evaluation function which has as variables the first shape correction parameter and the second correction parameter and evaluates shape data obtained by correcting the measurement data of the first shape by the first shape correction parameter and shape data obtained by correcting the measurement data of the second shape by the second correction parameter falls within a tolerance range, and a combining unit configured to generate shape data of an entire region including the first partial region and the second partial region by respectively correcting the measurement data of the first shape and the second shape using the determined values of the first shape correction parameter and the second correction parameter, and combining the corrected shape data.

Further features of the present invention will become apparent from the following description of exemplary embodiments (with reference to the attached drawings).

### BRIEF DESCRIPTION OF THE DRAWINGS

FIG. 1 is a view for explaining a conventional stitch technique;

FIG. 2 is a view for explaining a problem with the conventional stitch technique;

FIG. 3 is a view for explaining a stitch technique according to the first embodiment;

FIG. 4 is a view for explaining a stitch technique according to the second embodiment;

FIG. 5 is a view for explaining interference between a system error parameter and a shape correction parameter;

FIG. 6 is a view for explaining a measurement error included in each measurement data;

FIG. 7 is a view for explaining a stitch technique according to the third embodiment;

FIG. 8 is a view for explaining a stitch technique according to the fourth embodiment;

FIG. 9 is a view for explaining a stitch technique according to the fifth embodiment;

FIG. 10 is a view showing the result of simulation accuracy evaluation according to the fifth embodiment;

FIG. 11 is a view showing the arrangement of a shape measurement apparatus according to the embodiment;

FIG. 12 is a flowchart illustrating the conventional stitch technique;

FIG. 13 is a flowchart illustrating the stitch technique according to the first embodiment;

FIG. 14 is a flowchart illustrating the stitch technique according to the third embodiment;

FIG. 15 is a flowchart illustrating the stitch technique according to the fourth embodiment; and

FIG. 16 is a block diagram showing the arrangement of a control unit.

### DESCRIPTION OF THE EMBODIMENTS

Various exemplary embodiments, features, and aspects of the invention will be described in detail below with reference to the drawings.

Preferred embodiments of the present invention will be described in detail below with reference to the accompanying drawings. Note that the following embodiments are not intended to limit the present invention, and only show detailed examples advantageous for implementing the present invention. In addition, not all the combinations of features described in the following embodiments are essential to the solving means of the present invention.

### First Embodiment

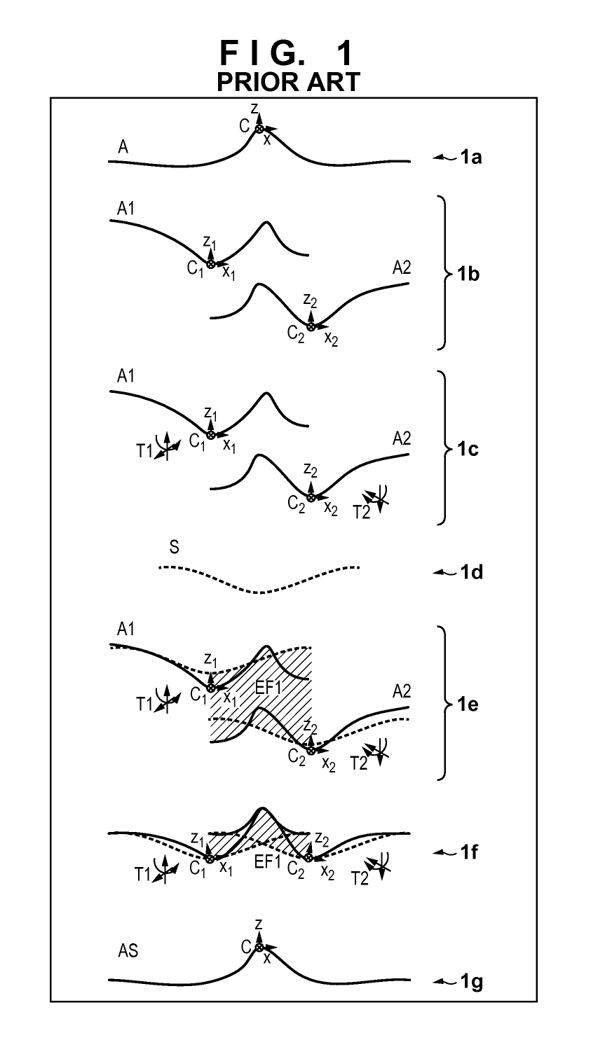

FIG. 1 shows a conventional stitch technique. FIG. 12 is a flowchart illustrating the conventional stitch technique. The conventional stitch technique is described in, for example, Japanese Patent Laid-Open No. 2004-125768. For the sake of simplicity, when connecting the shape data of two partial regions on a surface to be measured using overlapping measurement regions, especially connection at an arbitrary section in partial measurement data will be explained. Note that it will be understood that there is no difference in essence of the technique even when the shape data of three or more partial regions are connected.

Referring to FIG. 1, 1a shows the sectional shape of a surface A to be measured of an object to be measured. The surface A to be measured includes coordinates C serving as a reference, and X-, Y-, and Z-axes are defined. A shape measurement apparatus serving as a shape calculation apparatus according to the present invention measures the first partial region on the surface A to be measured, thereby obtaining data of the first shape of the first partial region (steps S1 and S2 of FIG. 12). The shape measurement apparatus also measures the second partial region on the surface A to be measured, which partially overlaps the first partial region, thereby obtaining data of the second shape of the second partial region (steps S1 and S2). Referring to FIG. 1, 1b shows the obtained first and second shape data. The first and second shape data are measured so as to have partially overlapping regions, and defined by A1 and A2. Each of A1 and A2 is a set of data points each having X-, Y-, and Z-axis components in a coordinate system C1 or C2 of the shape data of the corresponding partial region, given by:

A₁=[a₁₁,a₁₂, . . . ,a₁ᵢ, . . . ,a₁ₙ] (1)

A₂=[a₂₁,a₂₂, . . . ,a₂ᵢ, . . . ,a₂ₘ] (2)

a₁ᵢ└x₁ᵢ,y₁ᵢ,z₁ᵢ┐ (3)

a₂ⱼ=└x₂ⱼ,y₂ⱼ,z₂ⱼ┐ (4)

In 1c of FIG. 1, an orientation error in the obtained shape data is defined using an orientation error parameter T (step S3). The orientation error parameter T is formed from sub parameters for defining rotation and translation of the data A1 or A2 while maintaining the shape.

More specifically, for the data A1, the sub parameters of an orientation error parameter T1 are θ1, φ1, and ψ1 that correspond to rotation amounts with respect to the X-, Y-, and Z-axes, respectively, and α1, β1, and γ1 that correspond to translation amounts with respect to the X-, Y-, and Z-axes, respectively. Similarly, for the data A2, the sub parameters of an orientation error parameter T2 are θ2, φ2, and ψ2 respectively corresponding to rotation amounts, and α2, β2, and γ2 respectively corresponding to translation amounts. The orientation error parameters T1 and T2 are defined as coordinate transformation matrices given by:

$$\begin{matrix}{T}_{1} = [ \begin{matrix}cos {φ}_{1} cos {ϕ}_{1} & - cos {φ}_{1} sin {ϕ}_{1} & sin {φ}_{1} & {α}_{1} \\ \begin{matrix}cos {θ}_{1} sin {ϕ}_{1} + \\ sin {θ}_{1} sin {φ}_{1} cos {ϕ}_{1}\end{matrix} & \begin{matrix}cos {θ}_{1} cos {ϕ}_{1} - \\ sin {θ}_{1} sin {φ}_{1} sin {ϕ}_{1}\end{matrix} & - sin {θ}_{1} cos {φ}_{1} & {β}_{1} \\ \begin{matrix}sin {θ}_{1} sin {ϕ}_{1} - \\ cos {θ}_{1} sin {φ}_{1} cos {ϕ}_{1}\end{matrix} & \begin{matrix}sin {θ}_{1} cos {ϕ}_{1} + \\ cos {θ}_{1} sin {φ}_{1} sin {ϕ}_{1}\end{matrix} & cos {θ}_{1} cos {φ}_{1} & {γ}_{1} \\ 0 & 0 & 0 & 1\end{matrix} ] & ( 5 ) \\ {T}_{2} = [ \begin{matrix}cos {φ}_{2} cos {ϕ}_{2} & - cos {φ}_{2} sin {ϕ}_{2} & sin {φ}_{2} & {α}_{2} \\ \begin{matrix}cos {θ}_{2} sin {ϕ}_{2} + \\ sin {θ}_{2} sin {φ}_{2} cos {ϕ}_{2}\end{matrix} & \begin{matrix}cos {θ}_{2} cos {ϕ}_{2} - \\ sin {θ}_{2} sin {φ}_{2} sin {ϕ}_{2}\end{matrix} & - sin {θ}_{2} cos {φ}_{2} & {β}_{2} \\ \begin{matrix}sin {θ}_{2} sin {ϕ}_{2} - \\ cos {θ}_{2} sin {φ}_{2} cos {ϕ}_{2}\end{matrix} & \begin{matrix}sin {θ}_{2} cos {ϕ}_{2} + \\ cos {θ}_{2} sin {φ}_{2} sin {ϕ}_{2}\end{matrix} & cos {θ}_{2} cos {φ}_{2} & {γ}_{2} \\ 0 & 0 & 0 & 1\end{matrix} ] & ( 6 )\end{matrix}$$

As described in Japanese Patent Laid-Open No. 2004-125768, as for shape data obtained by an interferometer for which rotation about each axis can be calculated by linear approximation, rotation calculation may be implemented by linear calculation instead of nonlinear calculation. That is, in equations (5) and (6), cos ξ=1 and sin ξ=ξ may be set.

In 1d of FIG. 1, a system error common to the obtained shape data A1 and A2 is defined using a system error parameter, as indicated by a dotted line (step S4). To obtain a value at arbitrary coordinates in the data A1 and A2, a system error parameter S is desirably defined as a function S given by:

S=S(x,y) (7)

The function S may return a coordinate value z for arbitrary input values x and y, or return coordinate values x′, y′, and z for the arbitrary input values x and y. The former corresponds to, for example, a shape error of the reference surface of the interferometer. The latter corresponds to, for example, a case in which an error in the in-plane direction such as distortion in the interferometer is included.

Using orthogonal polynomials as a function in a given measurement region facilitates calculation. Therefore, orthogonal polynomials are desirably adopted as the function S. More specifically, there are provided Zernike polynomials, XY polynomials orthogonalized using the Gram-Schmidt orthogonalization method, and the like.

As will be readily understood, the function S desirably has no linear components. Otherwise, the function is approximately equal to the above-described rotation calculation of the orientation error parameter, and subsequent optimization calculation may not converge.

In the Zernike polynomials generally used, the first to third terms are linear components, and are desirably removed. In a function other than the Zernike polynomials as well, similarly defined linear components are desirably removed.

In 1e of FIG. 1, an evaluation function EF1 for the steps shown in 1c and 1d is created (step S5). For example, the evaluation function EF1 is expressed by:

EF1=Σ(A₁·T₁·S−A₂·T₂·S)² (8)

In equation (8), • represents the action of a parameter on the shape data. The action includes not only integration of the data and the parameter but also addition and subtraction. That is, after causing the orientation error parameter T1 and the system error parameter S to act on the shape data A1 and the orientation error parameter T2 and the system error parameter S to act on the shape data A2, the difference between the obtained values is obtained and squared. In other words, this evaluation function is used to evaluate shape data obtained by correcting the shape data by the parameters. More specifically, the evaluation function EF1 corresponds to the difference between Z values in the overlapping regions of the corrected shape data, as shown in 1e of FIG. 1. By, for example, minimizing the evaluation function, the integrity between the shape data becomes high. This means that an optimum stitch solution is obtained.

Note that since the X and Y coordinates in the shape data A1 and A2 do not basically coincide with each other in the overlapping regions of the data, it is a common practice to interpolate these data, calculate Z values at arbitrary X and Y coordinates, and obtain the difference between the Z values. As a coordinate system at this time, a global coordinate system C independent of each measurement result may be defined, or one of coordinate systems C1 and C2 of respective measurement results may be used.

In 1f of FIG. 1, the above-described evaluation function EF1 is minimized. Assume that the value of each parameter shown in 1c and 1d can be changed so as to minimize the evaluation function EF1. In this step, if linear calculation is performed, it is possible to uniquely obtain the solution of each parameter by linear least squares (step S6). Even if nonlinear calculation is necessary, it is possible to determine each parameter by nonlinear least squares or a solution using singular value decomposition.

In 1g of FIG. 1, data (stitch shape data) AS of a surface shape obtained by connecting the respective partial regions is calculated based on the respective determined respective parameters by concatenating (combining) the shape data of the first partial region and that of the second partial region (step S7). At this time, after correcting each of the shape data A1 and A2 using the correction parameters T and S, stitch measurement data interpolated from the respective shape data is created on the coordinate system C including the respective data.

According to the aforementioned conventional stitch technique, it is possible to concatenate the shape data of a plurality of regions, thereby obtaining the shape data of a larger region.

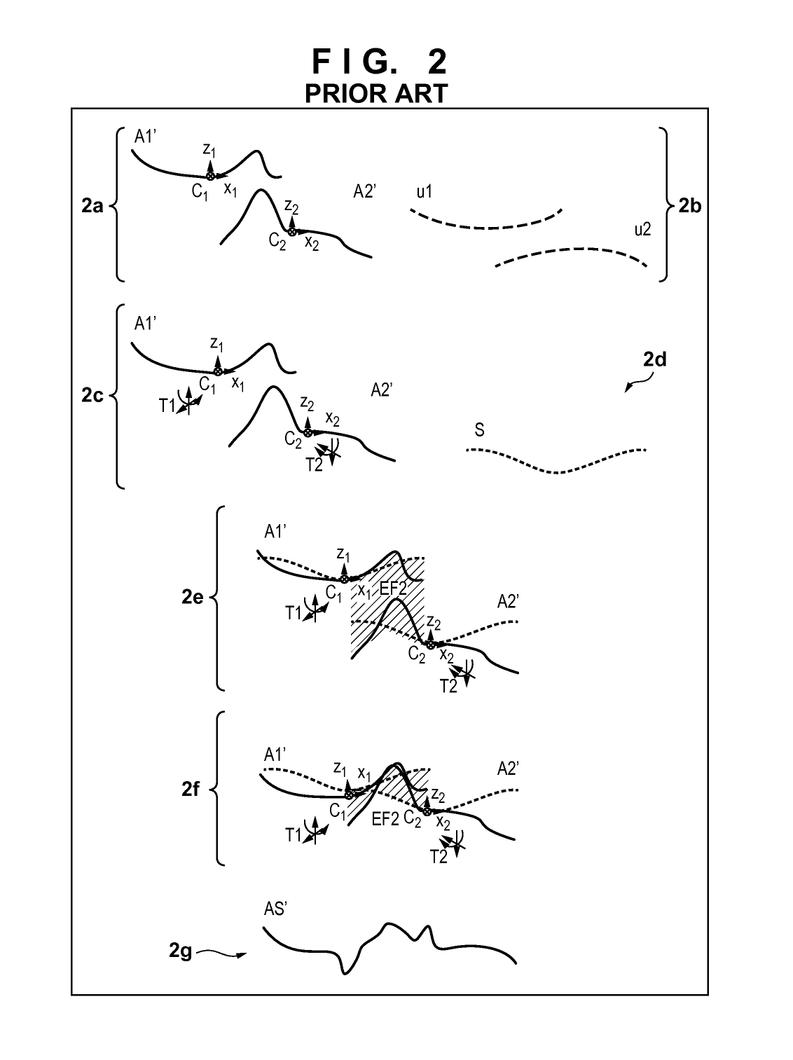

In the conventional stitch technique shown in FIG. 1, however, it is required that each shape data includes no independent error other than a system error. FIG. 2 shows a case in which each of first shape data A1′ and second shape data A2′ measured by dividing the surface A to be measured includes an independent error. The obtained data shown in 2a of FIG. 2 include measurement errors u1 and u2 shown in 2b, respectively. These data are expressed by:

A₁′=A₁u₁ (9)

A₂′=A₂u₂ (10)

These measurement errors u1 and u2 are considered to occur by the following factors:
a change in temperature in measurement environment in which measurement is in progress,
the deformation of an apparatus structure due to a change in weight balance caused by a change in position of the object to be measured on the measurement apparatus,
a vibration of the object to be measured,
a change in self-weight deformation due to a change in supporting position of the object to be measured, and
deformation caused by a change in frictional force at the supporting point of the object to be measured.

If the stitch step is advanced similarly to FIG. 1, when minimizing an evaluation function EF2 in 2f of FIG. 2, minimization is performed while including the measurement errors. That is, under adverse conditions that it is impossible to concatenate the respective measurement data without any errors due to the measurement errors, the orientation error parameters and system error parameter are calculated.

More specifically, stitch shape data AS′ shown in 2g of FIG. 2 includes a number of errors with respect to the original surface A to be measured which is shown in 2a. As features of the errors, discontinuity at the edge portions of the respective measurement data including the measurement errors u clearly appears, and a step-shaped error is generated in a stitch result.

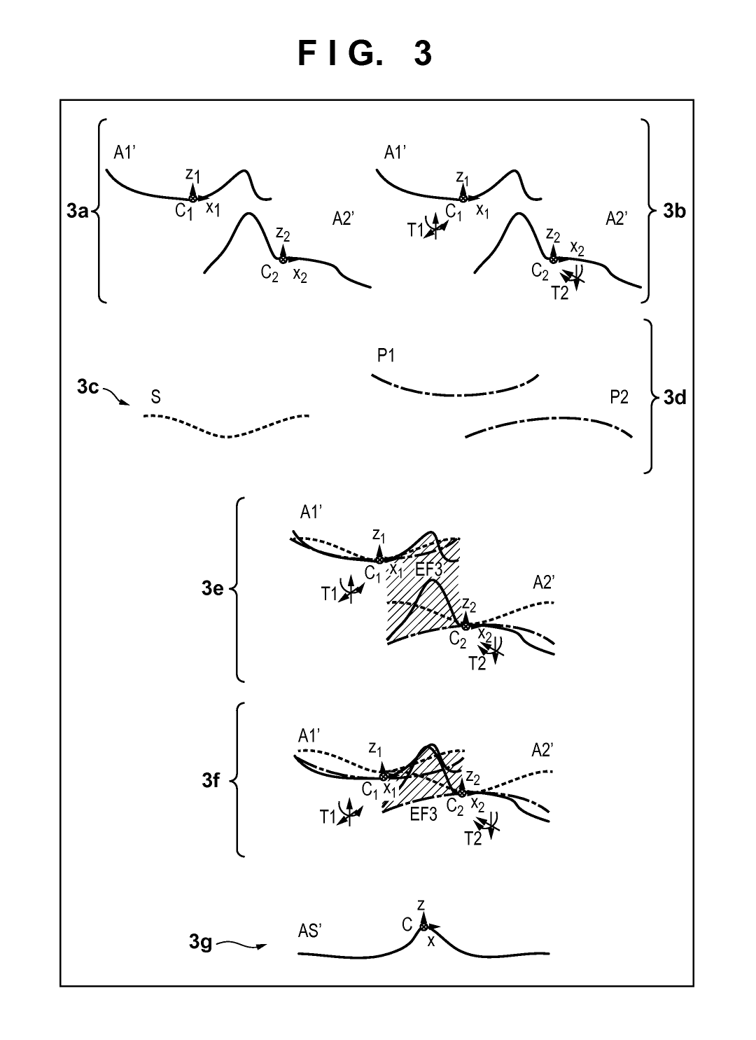

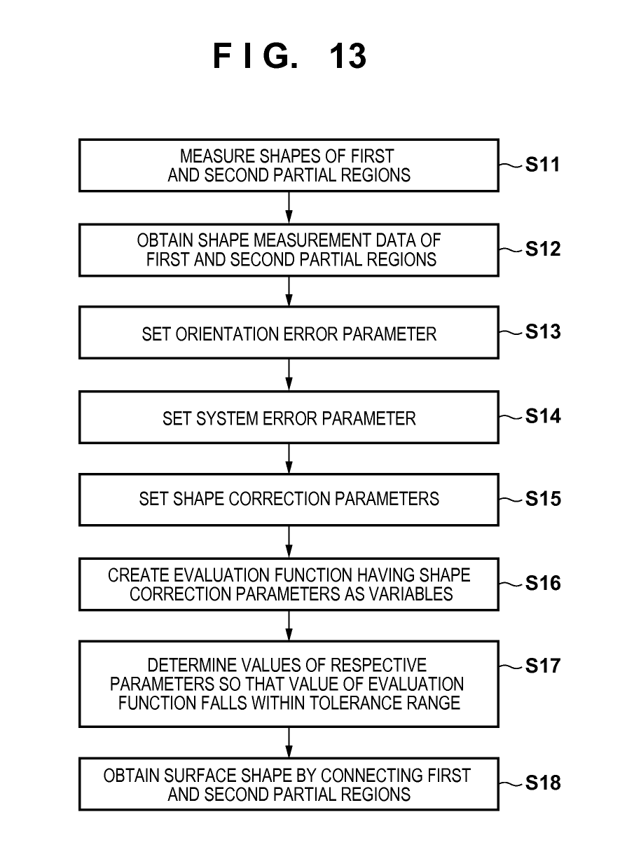

A stitch technique according to this embodiment will be described with reference to FIGS. 3 and 13. FIG. 3 is a view for explaining a stitch technique according to the first embodiment. FIG. 13 is a flowchart illustrating the stitch technique according to the first embodiment. According to the stitch technique of this embodiment, the problem with the conventional stitch technique shown in FIG. 2 is satisfactorily solved. Processes in steps S11 to S14 are the same as those in steps S1 to S4 of the stitch technique.

Obtained first shape data A1′ and second shape data A2′ that are shown in 3a of FIG. 3 include measurement errors u1 and u2, respectively, as indicated by equations (9) and (10). In 3d of FIG. 3, as parameters provided to each single surface, a first correction parameter P1 and a second correction parameter P2 are expressed as one-dot dashed lines in addition to an orientation error parameter T and a system error parameter S (step S15). Note that the first and second correction parameters are, for example, parameters for changing the measured shapes to compensate measurement errors. More specifically, the first shape correction parameter is a parameter for changing the first shape to compensate the measurement error included in the first shape measured in the first partial region. The second shape correction parameter is different from the first shape correction parameter, and is a parameter for changing the second shape to compensate the measurement error included in the second shape measured in the second partial region. The first and second shape correction parameters are expressed as functions given by:

P₁=P₁(x₁,y₁) (11)

P₂=P₂(x₂/y₂) (12)

Note that each of the functions P1 and P2 may return a coordinate value z for arbitrary input values x and y, or return coordinate values x′, y′, and z for the arbitrary input values x and y. The former corresponds to, for example, a shape error of the reference surface of the interferometer. The latter corresponds to, for example, a case in which an error in the in-plane direction such as distortion in the interferometer is included.

Using orthogonal polynomials as a function in a given measurement region facilitates calculation. Therefore, orthogonal polynomials are desirably adopted as a function P. More specifically, there are provided Zernike polynomials, XY polynomials orthogonalized using the Gram-Schmidt orthogonalization method, and the like.

Using the shape correction parameters makes it possible to individually correct the measurement errors respectively included in the shape data A1′ and A2′, as a matter of course. Consequently, an evaluation function EF3 shown in 3e of FIG. 3 is defined (step S16) by:

EF3=Σ(A₁u₁·P₁·T₁·S−A₂u₂·P₂·T₂·S)² (13)

The above evaluation function EF3 is the weighted squared error of the first shape data A1 and the second shape data A2. It will be understood that the weight of the first shape data A1 includes the first shape correction parameter P1 and the weight of the second shape data A2 includes the second shape correction parameter P2. In the optimization step, the shape correction parameters P1 and P2 as variables can be respectively set to satisfy functions given by:

P₁=u₁⁻¹ (14)

P₂=u₂⁻¹ (15)

As described above, in equation (13), • represents the action of a parameter on the shape data. The action includes not only integration of the data and the parameter but also addition and subtraction. It is thus possible to solve equation (13), similarly to equation (8). As an important point, in the optimization step, it is possible to simultaneously determine all the parameters.

In 3f of FIG. 3, each parameter is determined so that the value of the above-described evaluation function EF3 is equal to or smaller than a tolerance value (step S17). For example, the value of each parameter can be changed to minimize the evaluation function EF3. In this step, if linear calculation is performed, it is possible to uniquely obtain the solution of each parameter by linear least squares. Even if nonlinear calculation is necessary, it is possible to determine each parameter by nonlinear least squares or a solution using singular value decomposition.

In 3g of FIG. 3, stitch shape data AS′ is calculated based on the respective determined parameters (step S18). At this time, each shape data is corrected using the respective determined parameters, and the corrected shape data are combined, thereby generating overall shape data representing the shape of the entire region including the first and second partial regions. More specifically, for example, each of the shape data A1′ and A2′ is corrected by the correction parameters T, S, and P. After that, stitch shape data interpolated from the respective shape data is created on the coordinate system C including the respective data.

According to the above-described stitch technique of this embodiment, even if the shape data of respective partial regions include different measurement errors, it is possible to satisfactorily concatenate the shape data of the plurality of regions, and obtain the data of a larger region at high accuracy.

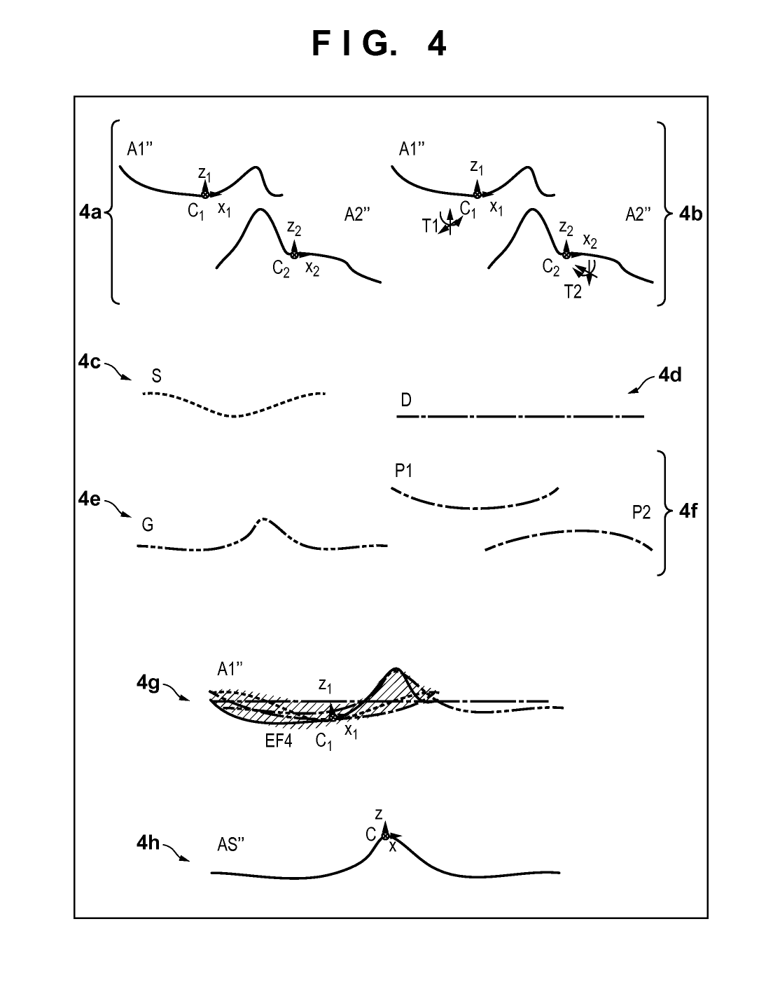

FIG. 4 is a view for explaining a stitch technique according to the second embodiment. FIG. 4 shows a case in which the shape correction parameters of the first embodiment are particularly applied to the stitch technique described in Japanese Patent Laid-Open No. 2009-294134. Referring to FIGS. 4, 4d and 4e show the parameter setting step described in Japanese Patent Laid-Open No. 2009-294134, in which design shape data D of a surface to be measured indicated by a one-dot dashed line and an overall shape parameter G indicated by a two-dot dashed line are set. Although the design shape data D is expressed as a planar shape for the sake of simplicity in this embodiment, it may be an arbitrary spherical surface, non-spherical surface, or free-form surface.

To obtain a value at arbitrary coordinates in A1″ and A2″, the overall shape parameter G is desirably defined as a function G given by:

G=G(x,y) (16)

The function G returns a coordinate value z for arbitrary input values x and y, and represents an approximate error shape in an entire region A″ including the first and second partial regions. With this parameter, when the region A″ actually has a shape including an error, it is possible to subtract the overall shape parameter G from measurement data by expressing the shape by the result of adding a continuous function to a design value. As a result, the measurement data to be processed has a narrow dynamic range with respect to stitch calculation, thereby reducing the calculation load.

Using orthogonal polynomials as a function in a given measurement region facilitates calculation. Therefore, orthogonal polynomials are desirably adopted as a function G. More specifically, there are provided Zernike polynomials, XY polynomials orthogonalized using the Gram-Schmidt orthogonalization method, and the like.

As will be readily understood, the function G desirably has no linear components. Otherwise, the function is approximately equal to the above-described rotation calculation of the orientation error parameter, and subsequent optimization calculation may not converge.

In this embodiment as well, as shown in 4f of FIG. 4, shape correction parameters P1 and P2 are defined.

In 4g of FIG. 4, an evaluation function EF4 is defined by:

$$EF 4 = {\sum }_{i}^{ } \sum {( D \cdot G - {A}_{i} {u}_{i} \cdot {P}_{i} \cdot {T}_{i} \cdot S )}^{2} \qquad ( 17 )$$

The above evaluation function EF4 is the weighted squared error of the design shape data of the entire region and the first and second shape data. It will be understood that the weight of the design shape data D includes the overall shape parameter G and the weights of the first shape data A1 and second shape data A2 include the first shape correction parameter P1 and the second shape correction parameter P2, respectively. The evaluation function EF4 is intended to minimize deviation of each shape data from the design shape of the surface to be measured. That is, the result of adding an error by the overall shape parameter G to the design shape data D is set as a reference, and the difference between the reference and the result of correcting measurement data Ai″ by the respective correction parameters P, T, and S is obtained. This processing is performed for each shape data, and the parameters that minimize the evaluation function EF4 are finally determined. Each parameter can be obtained by linear least squares or nonlinear least squares.

At this time, even if each measurement data includes a measurement error u, it is possible to correct the measurement error using the shape correction parameter P.

Referring to FIG. 4, 4h shows stitch shape data AS″ calculated based on the respective determined parameters. In this example, the stitch result is expressed by the sum of the design shape data D and the overall shape G, and an error can be made very small.

According to the above-described stitch technique of this embodiment, even if the shape data of respective partial regions include different measurement errors with respect to the design shapes, it is possible to satisfactorily concatenate the shape data of the plurality of regions, and obtain the shape data of a larger region at high accuracy.

Note that in this embodiment, an example of stitch calculation using an orientation error parameter and system error parameter in addition to the shape correction parameters has been explained. In fact, however, the embodiment may have a feature in which only parameters including at least the shape correction parameters are set. This indicates, for example, a case in which a system error or orientation error can be accurately corrected and an error occurs in only a partial shape.

The above-described embodiment assumes that the set parameters do not interfere with each other. That is, if the orientation error parameter, system error parameter, overall shape parameter, and shape correction parameters are independent of each other, it is possible to globally search for the minimum value of the evaluation function EF.

Alternatively, if these parameters depend on each other, the parameters interfere with each other at the time of minimization of the evaluation function EF. As a result, a local minimum value is found or the evaluation function does not converge.

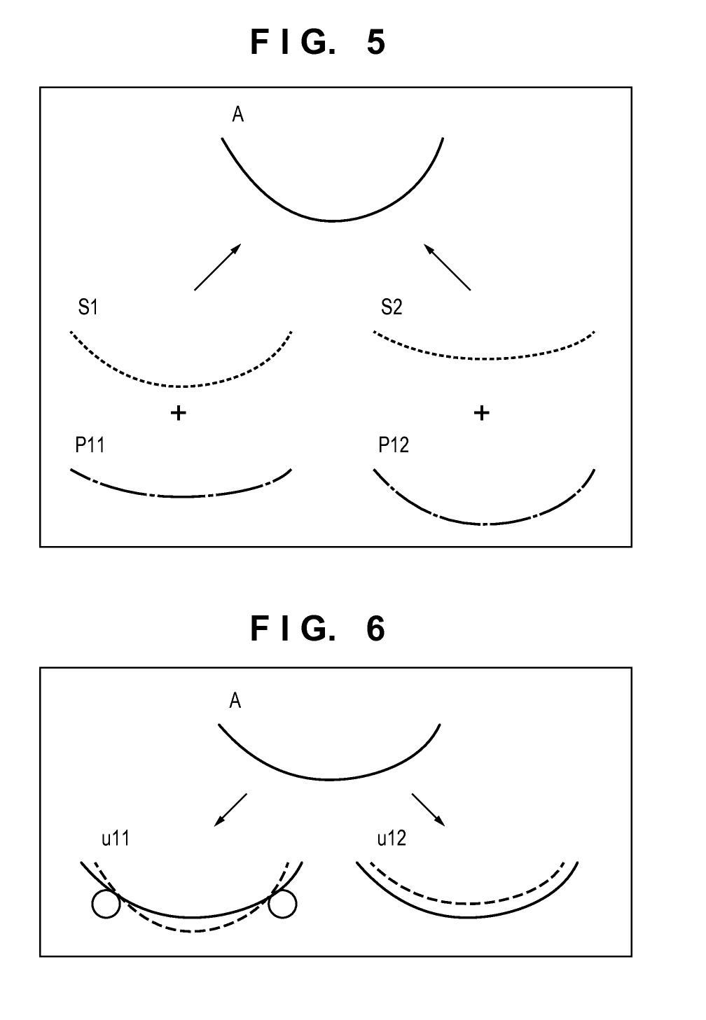

An example will be described with reference to FIG. 5. FIG. 5 shows a case in which a system error parameter S and the shape correction parameter P interfere with each other. If the system error parameter S depends on the shape correction parameter P1 in the partial region Al, the relationship between the parameters is expressed by:

S=S(x₁,y₁)=δP₁(x₁,y₁)=δP₁ (18)

That is, an equation having S and P is uncertain, and it is impossible to determine whether the target shape includes a system error or is a really existing shape. FIG. 5 shows a case in which an error expressed by a curvature is included. For the shape of the measurement region A, even if an arbitrary system error parameter is represented by S1, the shape correction parameter need only be set to P11 so as to satisfy equation (18). If the system error parameter is defined by S2, the shape correction parameter need only be set to P12. Therefore, parameters to be obtained are not uniquely determined.

In such case, the problem can be solved by selecting parameters to be independent of each other so that the parameters do not interfere or approximately interfere with each other.

FIG. 6 shows a case in which the property of the measurement error u is examined. It is examined in detail how the above-described factor of the measurement error influences on each measurement data. When, for example, an object to be measured is stressed by the influence of the supporting state on the apparatus, the shape of the object is deformed into a convex shape having a low spatial frequency, as indicated by u11. Alternatively, when the temperature of the object to be measured on the apparatus decreases, the overall object shrinks to be deformed into a shape having a low spatial frequency, as indicated by u12.

When the deformed shape is expressed by general Zernike polynomials, the shape (lower-order shape) of the fourth to ninth Zernike terms often dominates the deformed shape. In other words, the fourth to ninth Zernike term components are appropriately set as the shape correction parameters in this case.

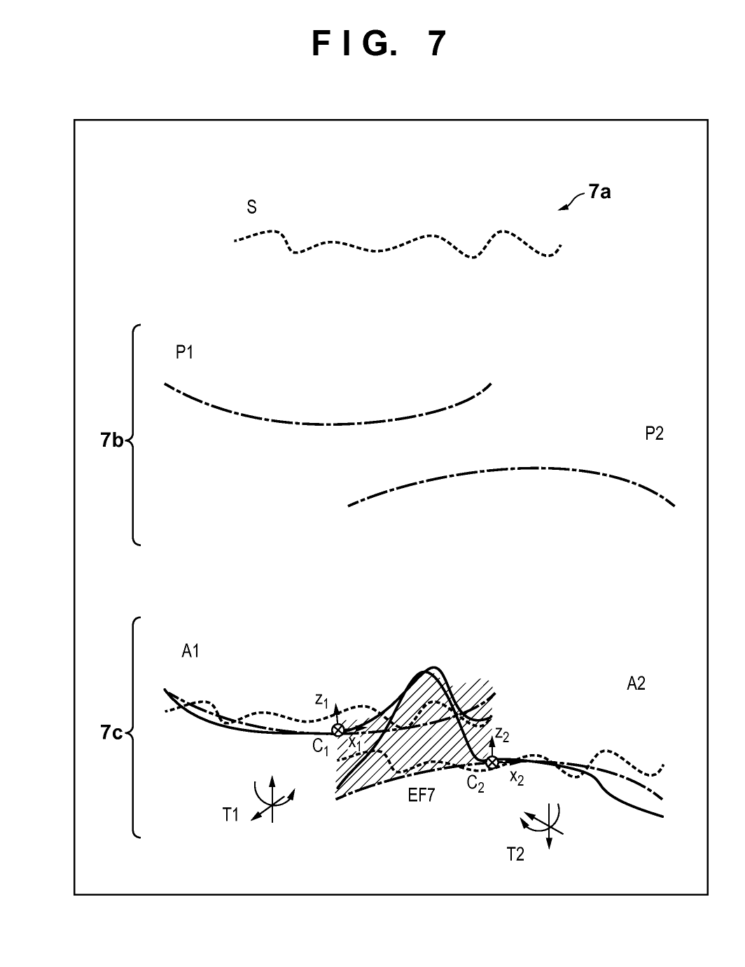

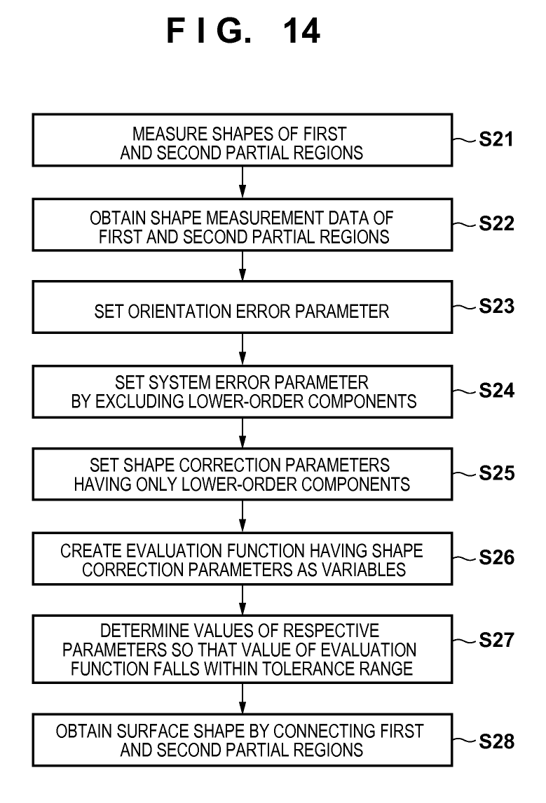

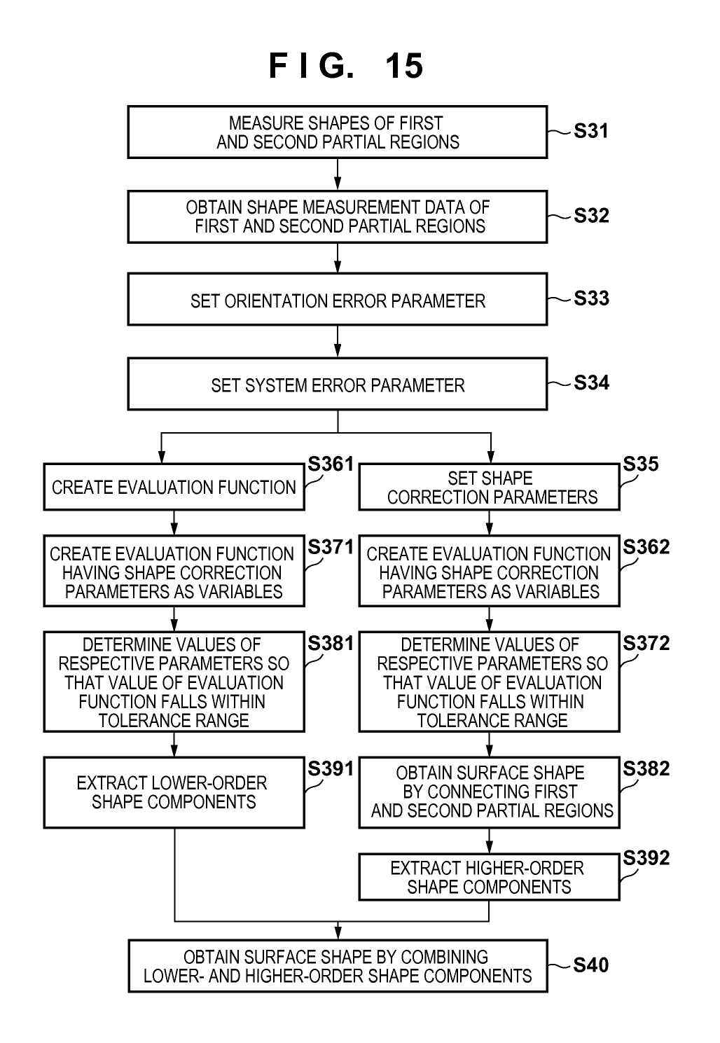

FIG. 7 is a view for explaining a stitch technique according to the third embodiment. FIG. 14 is a flowchart illustrating the stitch technique according to the third embodiment. Processes in steps S21 to S23 are the same as those in steps S11 to S13. In 7a of FIG. 7, a function S used as a system error parameter is set by excluding lower-order components (step S24). On the other hand, in 7b of FIG. 7, functions P1 and P2 used as shape correction parameters are set to have only lower-order components (step S25). Processes in steps S26 to S28 are the same as those in steps S16 to S18. As a result, in 7c of FIG. 7, when minimizing an evaluation function EF7, it is possible to prevent interference between the parameters, thereby obtaining a measurement result with high connectivity.

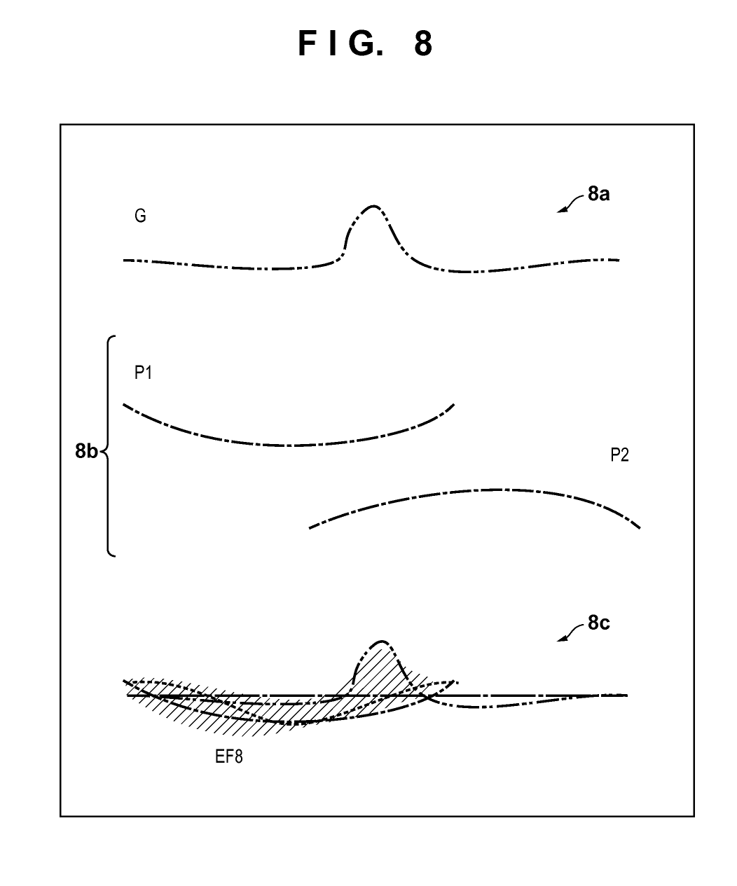

FIG. 8 is a view for explaining a stitch technique according to the fourth embodiment. In 8a of FIG. 8, a function G used as an overall shape parameter is set by excluding lower-order components. On the other hand, in 8b of FIG. 8, functions P1 and P2 used as shape correction parameters are set to have only lower-order components. As a result, in 8c of FIG. 8, when minimizing an evaluation function EF8, it is possible to prevent interference between the parameters, thereby obtaining a measurement result with high connectivity.

In the above-described embodiments, it is possible to reduce the discontinuity of the respective partial regions by correcting measurement errors using the shape correction parameters. However, if the surface to be measured actually has an error shape, and the shape correction parameters act by including the error shape, the actual error shape may be unwantedly corrected. That is, a measurement result with an error smaller than the actual error is unwantedly obtained. Depending on an evaluation function, the actual error shape cannot be uniquely determined, and may diverge. This means that the surface to be measured cannot be accurately measured, thereby causing a measurement problem.

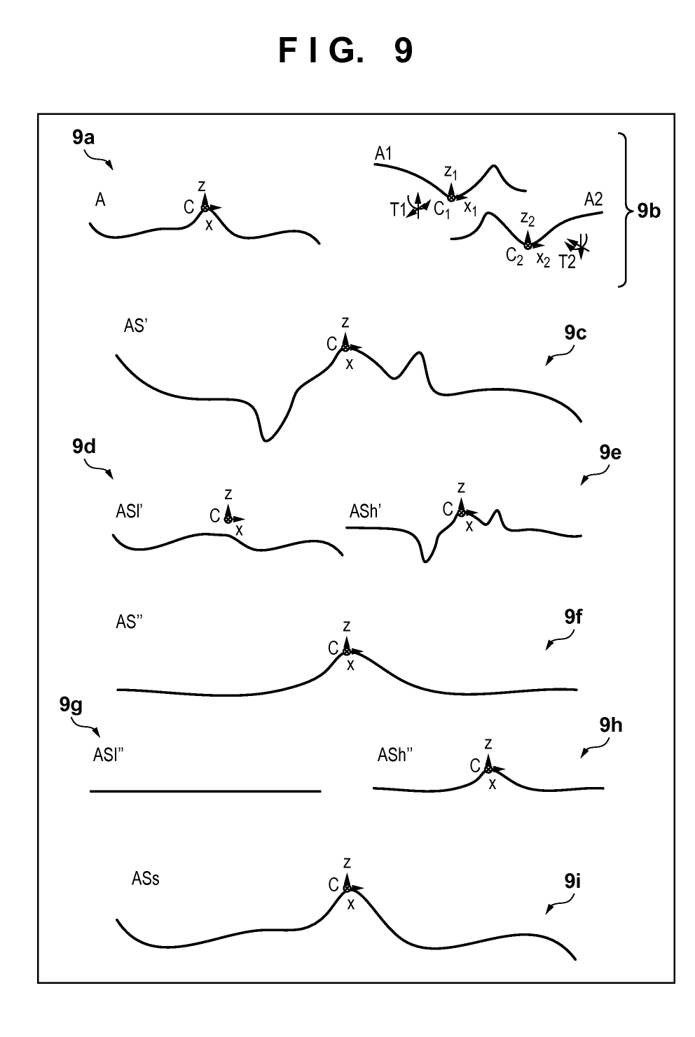

To solve this problem, a description will be provided with reference to FIG. 9. FIG. 9 is a view for explaining a stitch technique according to the fifth embodiment. FIG. 15 is a flowchart illustrating the stitch technique according to the fifth embodiment. Processes in steps S31 to S34 are the same as those in steps S11 to S14. A surface shape A including a lower- and higher-order shapes shown in 9a of FIG. 9 is measured, thereby obtaining the shape measurement data of each of partial regions A1 and A2 shown in 9b of FIG. 9.

A conventional stitch result obtained by using an orientation error parameter and system error parameter as in steps S361, S371, and S381, similarly to steps S5 to S7, is as shown in 9c of FIGS. 9, and includes a number of errors of higher-order shape components (step S381). Referring to FIGS. 9, 9d and 9e are graphs obtained by independently separating the stitch result into lower- and higher-order spatial frequency components. While the lower-order shape is calculated at sufficiently high accuracy, the higher-order shape includes an apparent error caused by stitching.

On the other hand, 9f of FIG. 9 shows a stitch result calculated by including shape correction parameters in an evaluation function as in steps S35, S362, S372, and S382, similarly to steps S15 to S18. As a result of correcting the lower-order shape components of the surface shape A by the shape correction parameters, the lower-order shape itself is lost in a surface shape A′ as a combining result. Referring to FIGS. 9, 9g and 9h are graphs obtained by independently separating the combining result into lower- and higher-order spatial frequency components. While the lower-order shape is apparently lost, the higher-order shape is reproduced at sufficiently high accuracy.

In this embodiment, in 9i of FIG. 9, the lower-order shape components shown in 9d and the higher-order shape components shown in 9h are extracted (steps S391 and S392), and combined into one surface shape A″ (step S40). It is desirable that the lower- and higher-order shape components are independent of each other, and include all spatial frequency regions. It is apparent that any specific calculation is not necessary since the independent components are added to combine the respective spatial frequency regions.

The above control processing will be summarized. As described above, overall shape data is generated using the evaluation function indicated by equation (13) or (17) (steps S35 to S382). After that, higher-order spatial frequency components H of the overall shape data are generated (9h of FIG. 9 and step S392). Instead of the evaluation function indicated by equation (13) or (17), a conventional evaluation function (second evaluation function) without any shape correction parameters is used (step S361). Next, lower-order spatial frequency components L of the thus obtained overall shape data are generated (9d of FIG. 9 and steps S371 to S391). Overall shape data is generated by combining the higher-order spatial frequency components H and lower-order spatial frequency components L (9i of FIG. 9 and step S40).

According to the embodiment, while maintaining the advantage of the first embodiment that it is difficult for a combining operation to cause a higher-order component error, it is possible to avoid, by using the conventional method, the disadvantage that a lower-order shape components include an error depending on a selected evaluation function.

Note that in this embodiment, the above-described method of determining parameters is divided into two patterns. The number of patterns is not limited to two. It will be readily understood that more patterns may be used depending on a measurement target.

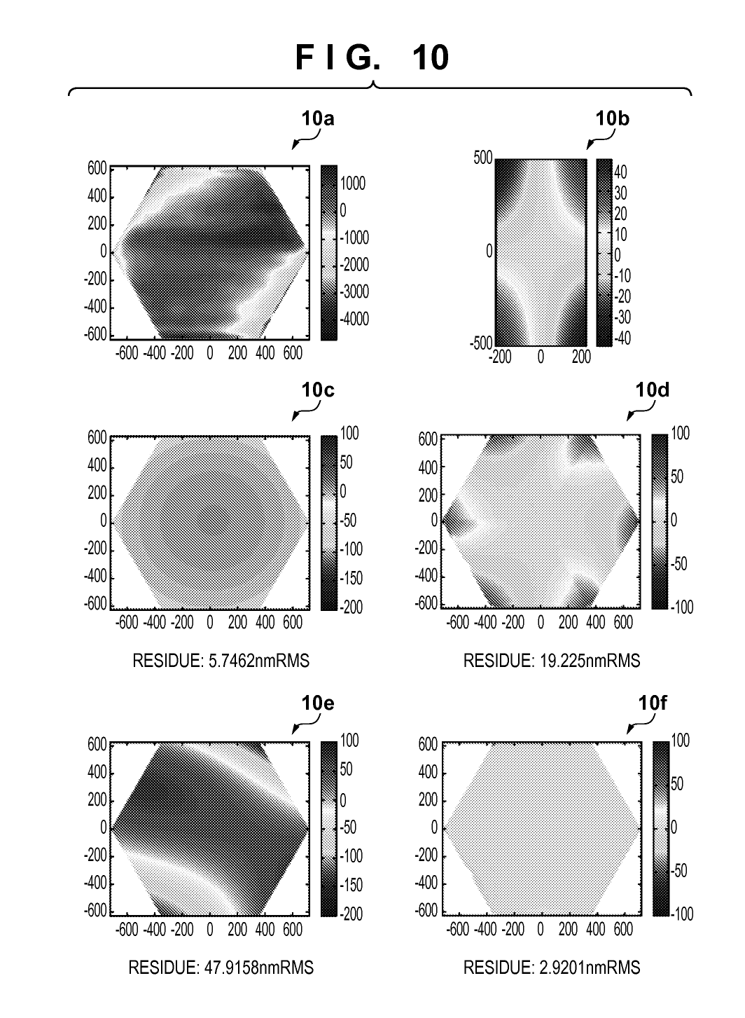

FIG. 10 shows the result of simulation performed for an actual combining result obtained when the fifth embodiment is applied. A hexagonal object to be measured, which is shown in 10a of FIG. 10, is divided into six partial regions, and the respective partial regions are combined. At this time, lower-order shape errors corresponding to the fourth to ninth Zernike term components shown in 10b are randomly added to the respective regions as measurement errors. The partial region data are combined, and the surface shape difference between the combining result and the object shown in 10a is evaluated. The surface shape difference is a combining error caused by stitching, and is preferably smaller.

A combining result obtained without using any shape correction parameters is shown in 10c and 10d. The lower-order components (the fourth to ninth Zernike term components) are 5.7 nm RMS while the higher-order components (the 10th Zernike term component and subsequent term components) are 19 nm RMS. On the other hand, 10e and 10f show a combining result obtained using the fourth to ninth Zernike terms as partial shape parameters. The lower-order components are 48 nm RMS and the higher-order components are 2.9 nm RMS.

From this simulation result, for the lower-order components, the ratio of an error when no shape correction parameters are used to that when the shape correction parameters are used is about 1:0.12. Consequently, it is more advantageous not to use the shape correction parameters. On the other hand, for the higher-order components, the ratio of an error when no shape correction parameters are used to that when the shape correction parameters are used is about 1:0.15. Consequently, it is more advantageous to use the shape correction parameters.

In this simulation, the lower-order components are defined by the fourth to ninth Zernike terms. This is because an error provided as a measurement error is a lower-order shape. In different data as well, it is desirable to determine patterns into which spatial frequency components are divided in accordance with shape components and an assumed measurement error.

In this simulation, the spatial frequency components are divided into two regions. However, the number of patterns is not limited to two. It will be readily understood that more patterns may be used depending on a measurement target.

According to the above-described measurement method of combining partial shapes, it is possible to accurately calculate the overall shape of an object to be measured that has low measurement reproducibility in each partial measurement operation by reducing an error caused by combining, especially a higher-order spatial frequency error.

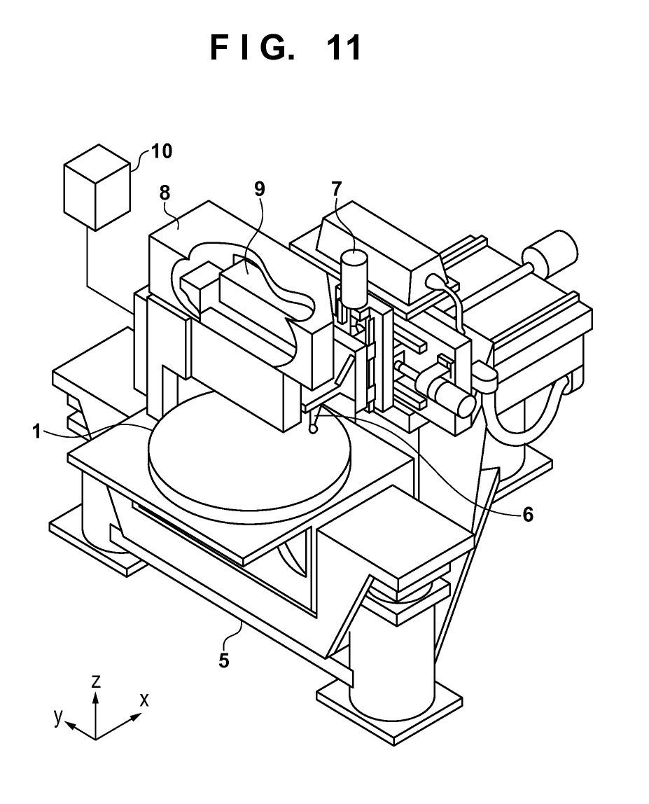

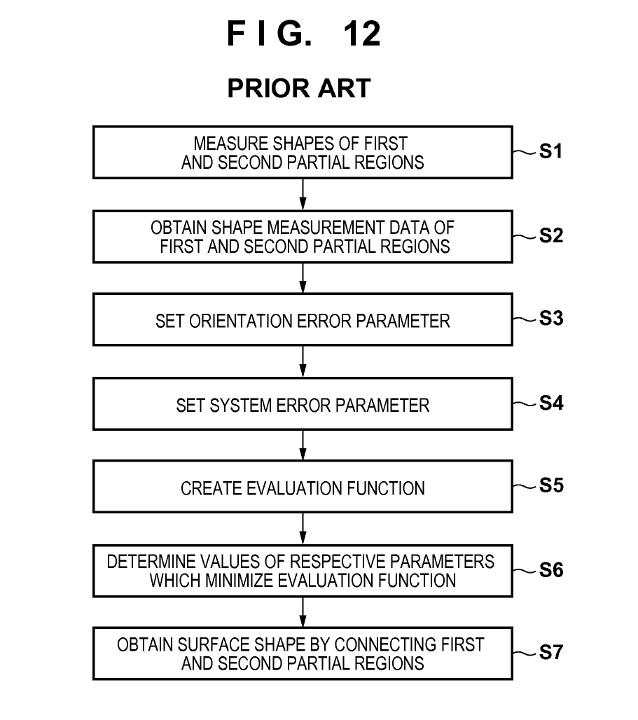

FIG. 11 is a view showing an example of the arrangement of a shape measurement apparatus for implementing the shape measurement method according to the above-described embodiment. An target object 1 is mounted on an apparatus main body 5. A probe 6 is attached to a slide 7 movable in three axis directions, that is, X-, Y-, and Z-axis directions. It is possible to scan the surface of the target object 1 by pressing the probe 6 against the surface of the target object 1. The shape measurement apparatus measures the movement of the probe 6 at this time by using a reference mirror 9 fixed to a metrology frame 8 as a measurement reference. The shape error of the reference mirror 9 may be a main factor to cause a system error in the apparatus.

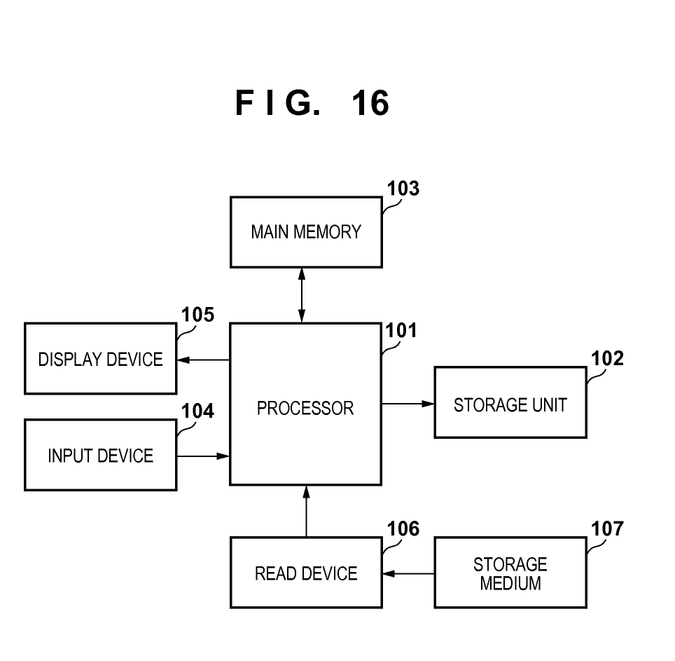

The shape measurement apparatus includes a control unit 10. FIG. 16 shows the arrangement of the control unit 10. The control unit 10 can include a processor such as a CPU for executing various calculation operations. For example, the control unit 10 includes a processor 101, a storage unit 102 storing programs and data, a main memory 103, an input device 104 such as a keyboard and mouse, a display device 105 such as a display, and a read device 106 for reading a storage medium 107. The storage unit 102, main memory 103, input device 104, display device 105, and read device 106 are connected to the processor 101. The storage medium 107 storing programs for implementing the functions of the above-described embodiment is attached to the read device 106, and the read device 106 reads out the programs from the storage medium 107 to store the readout programs in the storage unit 102. The control unit 10 can function as an obtaining unit for obtaining shape data, a determination unit for determining a shape correction parameter, and a combining unit for correcting and combining the first and second shape data to generate overall shape data. The control unit 10 obtains a surface shape by the stitch technique by executing software (programs) for implementing the functions of the above-described embodiment, which is stored in the storage unit 102. For example, in the first embodiment, the control unit 10 obtains measurement data of a surface shape in each partial region of the target object 1 measured by the probe 6, and executes steps S12 to S18 of the flowchart shown in FIG. 13, thereby obtaining the overall surface shape of the target object 1. Note that another embodiment is applicable instead of the first embodiment. Note that the software (programs) for implementing the functions of the above-described embodiment may be supplied to the storage unit 102 via a network or various storage media. The control unit 10 may be provided outside the shape measurement apparatus, or may constitute a computer whose processor or the like is independent of the shape measurement apparatus.

<Embodiment of Method of Manufacturing Article>

A method of manufacturing an article according to an embodiment is used to manufacture an article such as a metal part or an optical element. The method of manufacturing an article according to this embodiment includes a step of measuring the shape of an object to be measured using the above-described shape measurement apparatus, and a step of processing, based on the measurement result in the above step, the object to be measured. For example, the shape of the object to be measured is measured using the measurement apparatus, and the object to be measured is processed (manufactured) based on the measurement result so that the shape of the object to be measured conforms to a design value. The method of manufacturing an article according to this embodiment can measure the shape of the object to be measured at higher accuracy by using the measurement apparatus. Therefore, when compared to the conventional methods, this method is advantageous in at least one of the performance, quality, productivity, and production cost of an article.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2013-227525, filed Oct. 31, 2013 and 2014-185660, filed Sep. 11, 2014, which are hereby incorporated by reference herein in their entirety.

1. A shape calculation apparatus comprising:
an obtaining unit configured to obtain measurement data of a first shape of a first partial region on a surface to be measured, and obtain measurement data of a second shape of a second partial region partially overlapping the first partial region on the surface to be measured;
a determination unit configured to determine a value of a first shape correction parameter for changing the first shape to compensate a measurement error included in the measurement data of the first shape and a value of a second correction parameter for compensating a measurement error included in the measurement data of the second shape so that a value of an evaluation function which has as variables the first shape correction parameter and the second correction parameter and evaluates shape data obtained by correcting the measurement data of the first shape by the first shape correction parameter and shape data obtained by correcting the measurement data of the second shape by the second correction parameter falls within a tolerance range; and
a combining unit configured to generate shape data of an entire region including the first partial region and the second partial region by respectively correcting the measurement data of the first shape and the second shape using the determined values of the first shape correction parameter and the second correction parameter, and combining the corrected shape data.

2. The apparatus according to claim 1, wherein the second correction parameter is a second shape correction parameter that is different from the first shape correction parameter and changes the second shape to compensate the measurement error included in the measurement data of the second shape.

3. The apparatus according to claim 2, wherein the evaluation function is a weighted squared error of the measurement data of the first shape and the measurement data of the second shape, a weight of the measurement data of the first shape includes the first shape correction parameter, and a weight of the measurement data of the second shape includes the second shape correction parameter.

4. The apparatus according to claim 2, wherein the evaluation function is a weighted squared error of design shape data of the entire region and the measurement data of the first shape and the second shape, a weight of the design shape data includes a parameter for correcting a shape of the entire region, and weights of the measurement data of the first shape and the second shape include the first shape correction parameter and the second shape correction parameter, respectively.

5. The apparatus according to claim 2, further comprising a control unit configured to generate shape data by combining higher-order spatial frequency components of the shape data of the entire region generated by said combining unit, and lower-order spatial frequency components of the shape data of the entire region obtained by said combining unit when a second evaluation function having neither the first shape correction parameter nor the second shape correction parameter is used instead of the evaluation function.

6. The apparatus according to claim 2, wherein
the evaluation function further has parameters for compensating a system error and orientation errors included in the measurement data of the first shape and the second shape,
the system error is an error common to the first partial region and the second partial region, and
the orientation errors are different between the first partial region and the second partial region, and each orientation error includes a rotation error and a translation error while maintaining the shape.

7. A measurement apparatus for measuring a shape of a surface to be measured, comprising:
a shape calculation apparatus comprising:
an obtaining unit configured to obtain measurement data of a first shape of a first partial region on a surface to be measured, and obtain measurement data of a second shape of a second partial region partially overlapping the first partial region on the surface to be measured;
a determination unit configured to determine a value of a first shape correction parameter for changing the first shape to compensate a measurement error included in the measurement data of the first shape and a value of a second correction parameter for compensating a measurement error included in the measurement data of the second shape so that a value of an evaluation function which has as variables the first shape correction parameter and the second correction parameter and evaluates shape data obtained by correcting the measurement data of the first shape by the first shape correction parameter and shape data obtained by correcting the measurement data of the second shape by the second correction parameter falls within a tolerance range; and
a combining unit configured to generate shape data of an entire region including the first partial region and the second partial region by respectively correcting the measurement data of the first shape and the second shape using the determined values of the first shape correction parameter and the second correction parameter, and combining the corrected shape data,
wherein said measurement apparatus measures a shape of a first partial region on the surface to be measured, and measures a shape of a second partial region partially overlapping the first partial region on the surface to be measured,
said shape calculation apparatus obtains measurement data of a first shape of the measured first partial region, and obtains measurement data of a second shape of the measured second partial region by the obtaining unit, and
said shape calculation apparatus generates shape data of an entire region including the first partial region and the second partial region by the determination unit and the combining unit.

8. A shape calculation method comprising:
obtaining measurement data of a first shape of a first partial region on a surface to be measured, and obtaining measurement data of a second shape of a second partial region partially overlapping the first partial region;
determining a value of a first shape correction parameter for changing the first shape to compensate a measurement error included in the measurement data of the first shape and a value of a second correction parameter for compensating a measurement error included in the measurement data of the second shape so that a value of an evaluation function which has as variables the first shape correction parameter and the second correction parameter and evaluates shape data obtained by correcting the measurement data of the first shape by the first shape correction parameter and shape data obtained by correcting the measurement data of the second shape by the second correction parameter falls within a tolerance range; and
generating shape data of an entire region including the first partial region and the second partial region by respectively correcting the measurement data of the first shape and the second shape using the determined values of the first shape correction parameter and the second correction parameter, and combining the corrected shape data.

9. A method of manufacturing an article, comprising:
measuring shapes of a first partial region and second partial region of a surface to be measured;
obtaining a shape of a entire region including the first partial region and the second partial region by using a shape calculation method comprising:
obtaining measurement data of a first shape of a first partial region on a surface to be measured, and obtaining measurement data of a second shape of a second partial region partially overlapping the first partial region;
determining a value of a first shape correction parameter for changing the first shape to compensate a measurement error included in the measurement data of the first shape and a value of a second correction parameter for compensating a measurement error included in the measurement data of the second shape so that a value of an evaluation function which has as variables the first shape correction parameter and the second correction parameter and evaluates shape data obtained by correcting the measurement data of the first shape by the first shape correction parameter and shape data obtained by correcting the measurement data of the second shape by the second correction parameter falls within a tolerance range; and
generating shape data of an entire region including the first partial region and the second partial region by respectively correcting the measurement data of the first shape and the second shape using the determined values of the first shape correction parameter and the second correction parameter, and combining the corrected shape data; and
processing a surface of the entire region based on the calculated shape of the entire region.

10. A non-transitory storage medium storing a program for causing a computer to execute
obtaining measurement data of a first shape of a first partial region on a surface to be measured, and obtaining measurement data of a second shape of a second partial region partially overlapping the first partial region,
determining a value of a first shape correction parameter for changing the first shape to compensate a measurement error included in the measurement data of the first shape and a value of a second correction parameter for compensating a measurement error included in the measurement data of the second shape so that a value of an evaluation function which has as variables the first shape correction parameter and the second correction parameter and evaluates shape data obtained by correcting the measurement data of the first shape by the first shape correction parameter and shape data obtained by correcting the measurement data of the second shape by the second correction parameter falls within a tolerance range, and
generating shape data of an entire region including the first partial region and the second partial region by respectively correcting the measurement data of the first shape and the second shape using the determined values of the first shape correction parameter and the second correction parameter, and combining the corrected shape data.
